(19) United States
(12) Patent Application Publication
(10) Pub. No.: US 2024/0427742 A1
(43) Pub. Date: Dec. 26, 2024

(54) SYSTEMS AND METHODS FOR BUILDING AND EXECUTING A DATABASE DICTIONARY

(71) Applicants: Ruth Qingyu Guan, Diamond Bar, CA (US); Tao Guan, Diamond Bar, CA (US)

(72) Inventors: Ruth Qingyu Guan, Diamond Bar, CA (US); Tao Guan, Diamond Bar, CA (US)

(21) Appl. No.: 18/743,297

(22) Filed: Jun. 14, 2024

Related U.S. Application Data
(60) Provisional application No. 63/509,218, filed on Jun. 20, 2023.

(51) Int. Cl. G06F 16/21

(52) U.S. Cl. CPC G06F 16/213; G06F 16/212

(57) ABSTRACT

According to some aspects, systems and methods for optimizing the mapping and translating of natural language phrases into query code (e.g., SQL) via Generative AI are provided. Various embodiments employ optimizations to resolve at least some of the known issues with conventional LLM usage. Various embodiments are configured to leverage prompt engineering and/or fine tuning of a generative AI model to optimize the translation of natural language into code. For example, a database dictionary system manages creation of a database dictionary that describes an existing database target to a model. The database dictionary can be used as part of a query prompt input to an LLM. Employing the database dictionary, the output of the LLM is optimized for the specific database/context responsive to any request provided by a user. In various embodiments, the database dictionary is constructed and supplied to the LLM as part of a query prompt.

### RELATED APPLICATION

This application claims the benefit under 35 U.S.C. § 119(e) of U.S. Application Ser. No. 63/509,218, filed on Jun. 20, 2023, entitled “SYSTEMS AND METHODS FOR BUILDING AND EXECUTING A DATABASE DICTIONARY,” which is incorporated herein by reference in its entirety.

### BACKGROUND

Generative artificial intelligence has become more prevalent, efficient, and accurate in building conversational outputs based on predicting what words or groups of words should be output in response to inputs. Large language models (“LLM”) are now available that provide conversational outputs in response to natural language inputs via a prompt interface. The same or similar models have been trained to produce code or software outputs upon request. Generally, a user can input a query or natural language prompt into an interface and receive the output of the LLM as a response. There are known problems with the outputs generated. For example, the model can only function based on training data. Your response cannot encompass information the model does not have accurately. In another example, timely information or details that are not available in the model cannot be accurately returned. Further, the outputs may be invalid or fabricated while having the appearance of accuracy and/or functionality.

### SUMMARY

According to some aspects, systems and methods for optimizing the mapping and translating of natural language phrases into query code (e.g., SQL) via Generative AI are provided. Various embodiments employ the optimizations to resolve at least some of the known issues with conventional LLM usage and/or interfaces. Various embodiments are configured to leverage prompt engineering and/or fine tuning of a generative AI model to optimize the translation of natural language into query code. For example, a database dictionary system manages creation of a database dictionary that describes an existing database target to query. The database dictionary can be used as part of a natural language query prompt input to a LLM and/or as part of fine tuning the LLM. By employing the database dictionary, the output of the LLM can be optimized to generate queries for the specific database and/or a specific data context responsive to any natural language request provided by a user. In various embodiments, the database dictionary is constructed and supplied to the LLM as part of a query prompt that constrains the output produced to the specific data context desired.

According to one embodiment, the database dictionary implementation provides a novel approach for mapping or translating natural language phrases into query code (e.g., SQL) using generative AI. Although LLMs exist that can generate code responsive to natural language requests, the outputs produced are generic, and although they are likely to produce syntactically correct code, without actually aligning the output to a specific database that a user wishes to query it may not be usable.

According to one aspect, a system for generating query code in response to a natural language input is provided. The system comprises at least one processor operatively connected to a memory, the processor when executing configured to accept a request comprising a natural language input, associate the natural language input with a database dictionary definition, input the natural language and database dictionary definition into a large language model configured to produce query code, capture a query code output tailored to the request and the database dictionary definition, and display the query code output.

According to one embodiment, the database dictionary definition comprises summary information associated with the target database or a database schema of the target database. According to one embodiment, the system is configured to access a database dictionary definition responsive to selection in a user interface. According to one embodiment, the system is configured to update the database dictionary definition responsive to manual input in a user interface. According to one embodiment, the at least one processor is configured to accept database schema information, and automatically generate at least a portion of the database dictionary definition. According to one embodiment, the automatically generated code includes at least one of a table group definition, join definition, attribute definition, phrase definition, alias definition, or look up definition, union definition or comment definition.

According to one embodiment, the at least one processor is configured to fine-tune the large language model by the input of database dictionary definition. According to one embodiment, the at least one processor is configured to accept information for a database architecture for a target database execute a plurality of rules on the information for the database architecture automatically define table groups based on relationships established in the target database or a database schema associated with the target database based on execution of the plurality of rules, and store a database dictionary including at least the table groups for optimizing query code generation. According to one embodiment, the at least one processor is configured to automatically define at least one of a join definition, an attribute definition, a phrase definition, an alias definition, a look up definition, union definition, or a comment definition based on execution of the plurality of rules.

According to one embodiment, the at least one processor is configured to accept information for a database architecture for a target database, execute at least a plurality of rules on the information for the database architecture, and automatically define at least one of a table group, a join definition, an attribute definition, a phrase definition, an alias definition, a look up definition, a union definition, or a comment definition based on execution of the plurality of rules, and store a database dictionary including at least the table groups for optimizing query code generation.

According to one aspect, a computer implemented method for generating query code in response to a natural language input is provided. The method comprises accepting, by at least one processor, a request comprising a natural language input, associating, by the at least one processor, the natural language input with a database dictionary definition, inputting, by the at least one processor, the natural language and database dictionary definition into a large language model configured to produce query code, capturing, by the at least one processor, a query code output tailored to the request and the database dictionary definition, and displaying, by the at least one processor, the query code output.

According to one embodiment, the database dictionary definition comprises summary information associated with the target database or a database schema of the target database. According to one embodiment, the method comprises accessing, by the at least one processor, a database dictionary definition responsive to selection in a user interface. According to one embodiment, the method comprises updating, by the at least one processor, the database dictionary definition responsive to manual input in a user interface. According to one embodiment, the method comprises accepting, by the at least one processor, database schema information, and automatically generating, by the at least one processor, at least a portion of the database dictionary definition. According to one embodiment, the automatically generated code includes at least one of a table group definition, join definition, attribute definition, phrase definition, alias definition, or look up definition, union definition or comment definition.

According to one embodiment, the method comprises fine-tuning, by the at least one processor, the large language model by the input of database dictionary definition. According to one embodiment, the method comprises accepting, by the at least one processor, information for a database architecture for a target database, executing, by the at least one processor, a plurality of rules on the information for the database architecture, automatically defining, by the at least one processor, table groups based on relationships established in the target database or a database schema associated with the target database based on execution of the plurality of rules, and storing, by the at least one processor, a database dictionary including at least the table groups for optimizing query code generation. According to one embodiment, the method comprises automatically defining, by the at least one processor, at least one of a join definition, an attribute definition, a phrase definition, an alias definition, a look up definition, union definition, or a comment definition based on execution of the plurality of rules. According to one embodiment, the method comprises accepting, by the at least one processor, information for a database architecture for a target database, executing, by the at least one processor, at least a plurality of rules on the information for the database architecture, and automatically define at least one of a table group, a join definition, an attribute definition, a phrase definition, an alias definition, a look up definition, a union definition, or a comment definition based on execution of the plurality of rules, and store a database dictionary including at least the table groups for optimizing query code generation.

According to one aspect, a system for generating a database summary definition comprising at least one processor operatively connected to a memory is provided. The system comprises at least one processor when executing that is configured to accept information for a database architecture for a target database, execute at a plurality of rules on the information for the database architecture, and automatically define table groups based on relationships established in the target database or a database schema associated with the target database based on execution of the plurality of rules, store a database dictionary including at least the table groups for optimizing query code generation. According to one embodiment, the at least one processor is configured to automatically define at least one of a join definition, an attribute definition, a phrase definition, an alias definition, or a look up definition, union definition based on execution of the plurality of rules.

According to one aspect, a system for generating a database summary definition comprising at least one processor operatively connected to a memory is provided. The at least one processor when executing is configured to accept information for a database architecture for a target database, execute at a plurality of rules on the information for the database architecture, and automatically define at least one of a table group, a join definition, an attribute definition, a phrase definition, an alias definition, a look up definition, or a union definition based on execution of the plurality of rules, store a database dictionary including at least the table groups for optimizing query code generation.

According to one aspect, a computer implemented method for generating a database dictionary definition is provided. The method comprises obtaining a database schema and integrating the database schema into the database dictionary; wherein integrating the database schema into the database dictionary includes; adding attributes to the database dictionary, the attributes including any one or more of: table group definitions, join definitions, union definitions, attribute definitions, phrase definitions, alias definitions, or lookup definitions, and identifying respective attributes for table group definitions, join definitions, union definitions, attribute definitions, phrase definitions or lookup definitions in response to executing predefined rules, machine learning methods to query the respective attributes in a source database or the database schema.

According to one aspect, a method for generating a database dictionary definition is provided. The method comprises obtaining a database schema and adding the database schema to the database dictionary; based on predefined rules, machine learning methods to query and define table group definitions, join definitions, union definitions, attribute definitions, phrase definitions, alias definitions, and lookup definitions, and adding them to the database dictionary; based on predefined rules, using artificial intelligence models to identify table group definitions, join definitions, union definitions, attribute definitions, phrase definitions, alias definitions, and lookup definitions, and adding them to the database dictionary.

According to one embodiment, the method comprises based on machine learning methods, adding tables that meet predefined rules to the database dictionary; and using artificial intelligence models to discover table groups from all tables based on predefined rules and adding them to the database dictionary; based on machine learning methods, adding attribute definitions that meet predefined rules to the database dictionary; and using artificial intelligence models to identify attribute definitions from all tables based on predefined rules and adding them to the database dictionary; based on machine learning methods, adding lookup values that meet predefined rules to the database dictionary; and using artificial intelligence models to identify lookup tables from all tables based on predefined rules and finding lookup values based on the lookup tables to add to the database dictionary.

According to one embodiment, the method comprises based on predefined rules, to identify tables with the same structure, to generate union definitions using the identified tables with the same structure, and to add the union definitions to the database dictionary. According to one embodiment, the method comprises based on foreign keys or columns with same name and size, to generate join definitions, and to add the join definitions to the database dictionary. According to one embodiment, the method comprises based on existing views or stored procedures, to extract join definitions from existing codes, and to add the join definitions to the database dictionary.

Still other aspects, examples, and advantages of these exemplary aspects and examples, are discussed in detail below. Moreover, it is to be understood that both the foregoing information and the following detailed description are merely illustrative examples of various aspects and examples and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE DRAWINGS

Various aspects of at least one embodiment are discussed herein with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by references signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 is a block diagram of an example implementation, according to one embodiment;

FIG. 2 is an example screen capture of a user interface, according to one embodiment;

FIG. 3 is an example screen capture of a user interface, according to one embodiment;

FIG. 4 is an example process flow for generating a database dictionary, according to one embodiment;

FIG. 5 is an example process flow for generating a database dictionary, according to one embodiment; and

FIG. 6 is a block diagram of an example computer system improved by implementation of the functions, operations, and/or architectures described herein.

### DETAILED DESCRIPTION

According to various embodiments, the system interfaces with an AI model (e.g., an LLM) to build responses to queries. More specifically, the system is configured to generate structured query language code based on a query entered as a text input to a query prompt. The system is configured to leverage data domain knowledge to construct query language code that is specific to a data context tailored to the data a user wishes to interrogate. Conventional systems are available that allow users to access LLMs, and even produce SQL queries based on their text input. The inventors have realized that there are significant issues when SQL code is generated using conventional approaches. In a conventional approach, the LLM provides limited or no options to tailor the produced SQL query to a target database, and often the code produced appears correct but may contain errors. Thus, any code produced generally needs substantial rework (even when it is functional) by a skilled database administrator (“DBA”) to work on any specific database.

According to one aspect, the system utilizes a database dictionary definition as a way to improve mapping of phrases in natural language (e.g. English, French, and Chinese, etc.) to database query language (e.g. Structured Query Language SQL). The improved mapping enables the system to generate query code that can be used on a specific database. According to various embodiments, the system links a user's text input to the database dictionary definition which enables generation of improved and specific code relative to conventional implementation.

According to some embodiments, the system is configured to create a query prompt or a training set for fine tuning an LLM, e.g. GPT4, to generate improved/correct SQL code for natural language query on databases. In other embodiments, the system is configured to provide a resource to share or transfer business logic or domain knowledge. In one example, DBAs, data analysts, and/or data engineers can define files that contain information on their database schema, data, and/or values that optimize the production of query code when executed against an LLM. These definitions can be referred to as a database dictionary that can be provided as part of a user input prompt to a LLM query interface. According to one embodiment, coupling the database dictionary into the process enables the output of the LLM to provide context aware code without having any training on a specific database that a user wants to query. In other embodiments, the database dictionary can be used as training data to fine tune the output produced by an LLM.

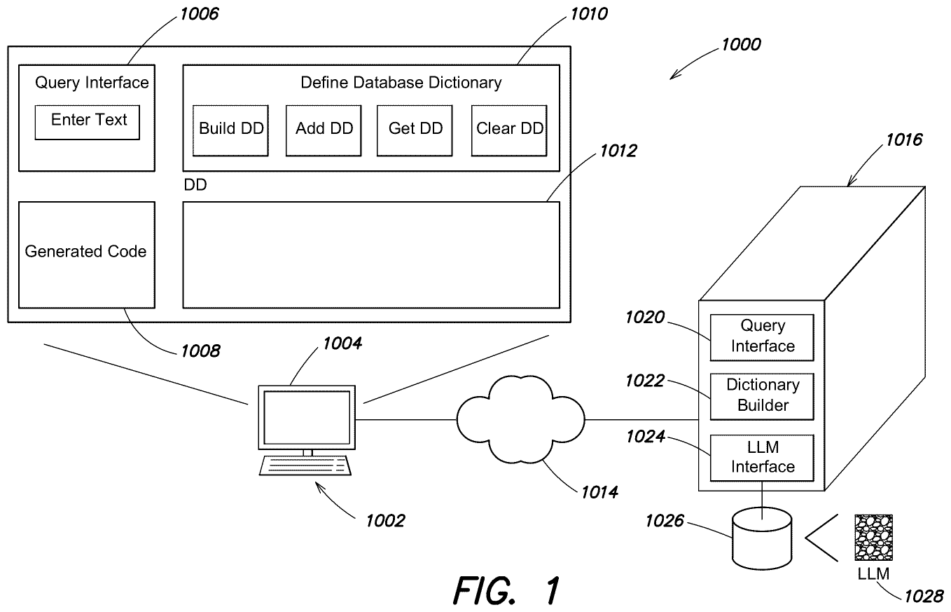

FIG. 1 is a block diagram of an example implementation that optimizes the use of a known LLM model interface (e.g., ChatGPT). Shown in FIG. 1 is a block diagram of an example implementation 1000. The example implementation includes a user system 1002, a database dictionary system 1016, and a large language model 1028 that allows a user to input a natural language request to produce executable query code on a target database.

The user can access their system 1002 via an interface display 1004. The interface display 1004 can include a query interface 1006 for entering natural language text. Upon submission of natural language text generated code can be displayed at 1008. The interface 1004 can include a database dictionary portion 1010. The database dictionary portion 1010 provides options and functions that enable the user to create a database dictionary, access a defined database dictionary, or remove a currently loaded database dictionary. Any loaded database dictionary can be shown in the interface at 1012.

According to one embodiment, when a database dictionary is loaded (e.g., shown at 1012), the database dictionary is provided as part of a natural language query that will be processed by a large language model (e.g., 1028). In various embodiments, the LLM 1028 can be accessed on a or using the database dictionary system 1016. In other embodiments. The database dictionary system can provide a database dictionary definition to a user system, and the user system is configured to supply the database dictionary definition when interacting with an LLM. In some embodiments, the LLM can be stored on the database dictionary system or can be accessed via third-party providers. In one example, the database dictionary system 1016 can operate as an interface to known LLM providers. An example provider includes the well-known ChatGPT.

According to some embodiments, the interface 1004 can be presented to a user to enable natural language inputs and to display generated code at 1008. The generated code at 1008 can be optimized according to a specific data context that is presented by a specific database, a database schema, and/or a database architecture, among other options. According to one embodiment, the database dictionary system 1016 can include a dictionary builder component 1022. The dictionary builder component is configured to build a database dictionary that can be used to control an output from a large language model or other AI model that is configured to accept natural language text and return code responsive to the input.

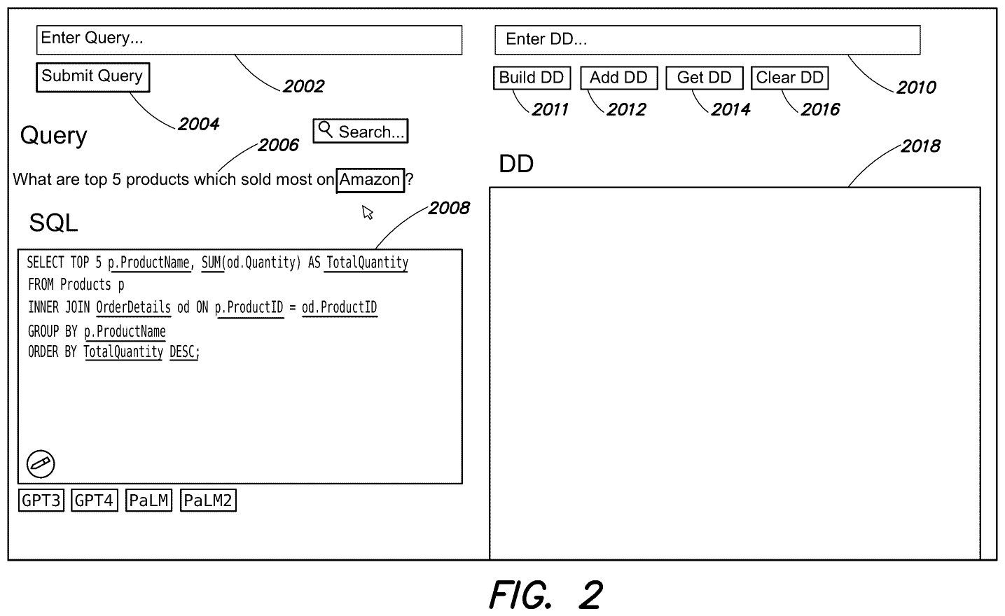

In conventional implementations, which include, for example, ChatGPT, the user is able to enter natural language text that requests the model produce code in response to their input. Shown in FIG. 2 is a query interface display without a database dictionary loaded. When a database dictionary is not loaded to optimize processing, the output produced is similar to conventional implementation. In the example shown in FIG. 2, a user inputs the natural language text “what are top five products which sold most on Amazon?”. For example, the user can enter text at 2002, select submit query 2004, and have the requested query display at 2006, with the code produced by a specific LLM at 2008. In this example, an LLM processes the natural language text input to produce query code that may return the result requested. Such conventional implementation fails to address the actual database being queried which may have data tables that do not match the produced code. For example, if the database targeted does not have a product name data table or column names that include “products” the code generated will produce errors or no output at all. The join command produced is especially suspect, as a given database may not have either table matching the names specified, and may not even separate the tables required to provide a response to the query.

Conventional approaches rely on being able to predict what words or word tokens are appropriate to return to a natural language request. These predictions are entirely dependent on the attributes the LLM is trained on. Thus, the ability of a LLM to provide query code that can execute a respective database is suspect. While the code may be syntactically correct, without aligning the operations to a target database (e.g., aligning table names, understanding locations of target data, etc.) the LLM cannot produce code that will execute properly.

According to various embodiments, the output predictions can be influenced by the text provided as part of a request. For example, if a user asks ChatGPT to summarize a document that they provide as part of the request, the input words allow the output produced by the model to reflect the action requested. If instead the user requests the model produce a summary of a known document (e.g., War and Peace—a well-known book), ChatGPT will produce an output based on the words predicted to be responsive to the request, and not necessarily a summarization of the words that appear in the book War and Peace.

Influencing the output via the language submitted as a request is referred to as prompt engineering. By submitting certain words in the prompt that is input to the LLM, the input words influence the prediction of the output and force the predicted output to conform to the input to a greater degree than an open ended or generic request.

According to some embodiments, the database dictionary component 1022 is configured to build a database dictionary (e.g. shown at 1012) which can be provided in its entirety (e.g., or in part) as part of a user request. By providing the database dictionary as part of the user's natural language request, the output of any associated LLM will account for the words supplied by the database dictionary. According to one embodiment, a user can access the database dictionary functions via the interface in FIG. 2 at 2011-2016, and once loaded the database dictionary can be shown at 2018. In various embodiments, the system and/or UI can include visual elements for a “Build DD” button which is configured to trigger automatic build functionality; an “Add DD” button which is configured to allow a user to add database dictionary manually; a “Get DD” button configured to get a database dictionary related to the NL query and input them to LLM to generate SQL code. Also shown in the UI, are options to select a specific LLM (e.g., GPT3, GPT4, PaLM and PaLM2, among other options).

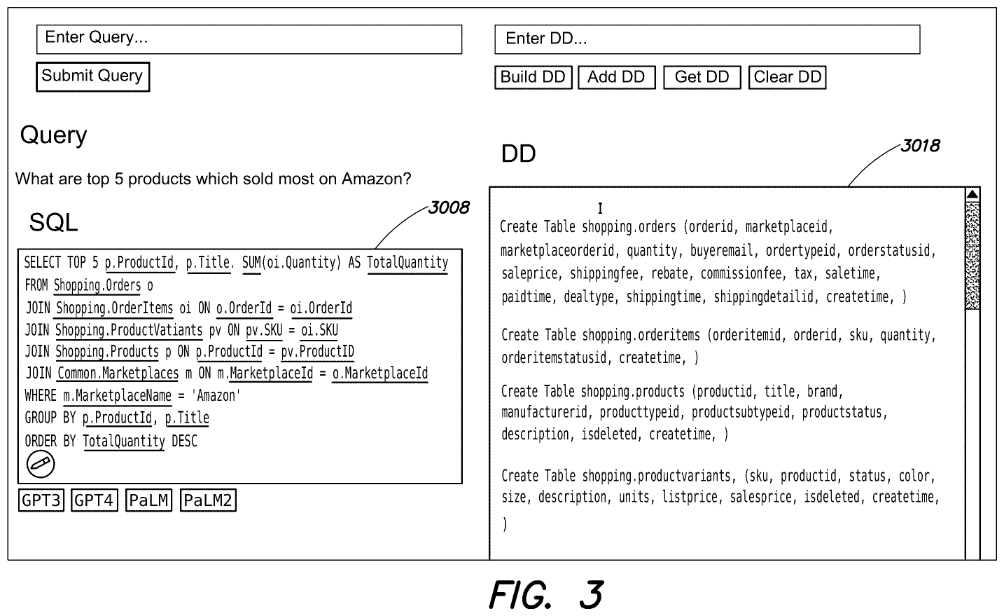

The same text query of FIG. 2 when accompanied by a database dictionary definition (e.g., 3018) is shown in FIG. 3. The output produced 3008 provides a detailed and contextually correct query for the database being targeted. The differences in the output code highlight the difficulty in using a conventional approach versus one that is contextual and tailored to the specific database. For example, the code produced in FIG. 2 would not execute appropriately on the user's database target. Whereas the code produced with the database dictionary (at 3008) is able to incorporate multiple joins on a plurality of different tables, and group the output by product ID and title with the filtering option of order by total quantity. Conventional implementations are simply unable to provide the same data context that is required to produce executable query code without expert intervention.

Returning to FIG. 1, the database dictionary system includes a query interface component 1020 that is configured to generate the interface display (e.g., 1004) that a user may interact with to produce query code. In further embodiments, the database dictionary system 1016 can include an LLM interface 1024 that is configured to provide access to third-party or external LLM systems. For example, the LLM interface can be configured to provide access to known LLM models (e.g., ChatGPT version 3, ChatGPT version 4, etc.), that may be accessed locally or via an Internet connection 1014. A number of other options are available both as local resources (e.g. stored in database 1026) or via external communication (e.g., 1014).

Various embodiments instantiate a plurality of components (e.g. query interface, dictionary builder, LLM interface, etc.) to provide functionality that enables a user to input natural language and receive executable query code as an output. Other embodiments can provide the same functionality without the respective components and, for example, a database dictionary system 1016 can be configured to provide the same functionality without the respective components. For example the functionality discussed herein with respect to building a database dictionary can be implemented by a dictionary builder component 1022 and/or by a database dictionary system 1016.

The following is an example definition in a database dictionary that can be produced by a dictionary builder component 1022:
CREATE PHRASE Order GMV AS
SELECT SalePrice+ShippingPrice+Saletax-Rebate FROM Orders

In the example, the “Order GMV” is a phrase in English. It is mapped to the following SQL query to show how order GMV is calculated:
SELECT SalePrice+ShippingPrice+Saletax-Rebate FROM Orders

Generally stated, the database dictionary system is a bridge between natural language (used by human beings) and database query language (e.g. SQL used by computers). It works like a normal dictionary of natural language, for example, English-Chinese dictionary which translates English words or phrases into Chinese. The database dictionary system translates words or phrases in natural language to database query language (e.g. SQL). It also contains some semantic knowledge in a database like table constraints, join, and union.

Many conventional systems include a “data dictionary” which is a collection of metadata such as object name, data type, size, classification, and relationships with other data assets. Conventionally a data dictionary acts as a reference guide on a database. For example, a SQL Server data dictionary stores information about a database's definition. The dictionary contains information about database objects such as tables, indexes, columns, datatypes, and views. The SQL Server Database management system (“DBMS”) uses a data dictionary to execute queries. In contrast, the database dictionary system defines natural language phrases used by a database. The system is configured to provide that information as part of a query prompt, input, or training data. The addition of this information to the query, for example, on a LLM enables the LLM to produce a context aware translation (e.g., an output specific to the database that will be queried) to a specific database query language (e.g. SQL).

### Example Implementation of the Database Dictionary System

According to one embodiment, a database dictionary system includes any one or more of the following components: a database schema, table groups, attributes, Lookup values, phrases, alias, joins, unions, and comments. In one example, the system can build a database dictionary for a database. And the database dictionary as defined can include any one or more or any combination of the following numbered elements.

### 1) Database Schema

According to various embodiments, the database schema includes the tables, fields, relationships, views, stored procedures, and other objects in a database. For example, the following is a table definition:

CREATE TABLE Orders (

| | |
|---|---|
| OrderId | NVARCHAR(64), |

```
  MarketplaceIdINT,
  MarketplaceOrderId NVARCHAR(512),
```

| | |
|---|---|
| Quantity | INT, |
| BuyerEmail | NVARCHAR(64), |
| OrderTypeId | INT, |
| OrderStatusId | INT, |
| SalePrice | MONEY, |
| ShippingFee | MONEY, |
| Rebate | MONEY, |

CommissionFee MONEY,

| | |
|---|---|
| Tax | MONEY, |
| SaleTime | DATETIME DEFAULT (getdate( )) NOT NULL, |
| PaidTime | DATETIME, |
| DealType | NVARCHAR(512), |
| ShippingTime | DATETIME, |

ShippingDetailId INT,

| | |
|---|---|
| CreateTime | DATETIME DEFAULT (getdate( )) NOT NULL, |

```
  CONSTRAINT PK_Shopping.Orders PRIMARY KEY CLUSTERED (OrderId
ASC),
  ......
  );
```

Stated broadly, a database schema contains detailed information about data structures and table relationships in a database.

### 2) Table Groups

The formal definition for Table Group is as follows:
CREATE TABLE GROUP GroupName AS TableName1, TableName2, . . . .

According to one embodiment, a table group can be defined as a set of tables which are related. For example, table Orders, OrderItems, OrderType, OrderStatus etc., can be defined as related tables. For a big database with hundreds or thousands of tables, a table group is a way to group related tables together to highlight the relationship of these tables.

In further embodiments, table groups can be configured to summarize connected or related tables into a named grouping, and define the relationship for use in created outputs from an AI model.

### 3) Attributes

According to some embodiments, the system can be configured to define an Attribute is as follows:
CREATE ATTRIBUTE AttributeName AS Attributes
where an Attribute is a property applied for objects in the database dictionary. For example,
DEFAULT CONSTRAINT, defines constraints applied to a table;
DEFAULT (Column Value) (e.g., TIME): defines which date/time column will be used if a table has multiple time columns, e.g. SaleTime, PaidTime, ShippingTime, CreateTime, etc.;

An example for attributes for an Orders table is defined as follows:
CREATE ATTRIBUTE OrderConstraint AS DEFAULT CONSTRAINT IsDeleted< >1 ON TABLE Orders
   The example above defines a default constraint attribute for the table Orders as isDeleted< >1. That is, when a SQL output for table Orders is generated, the system is configured to append the criteria isDeleted< >1 to exclude the deleted orders from a result produced by executing the generated query code.

Another example:
CREATE ATTRIBUTE OrderTime AS DEFAULT TIME SaleTime ON TABLE Orders
   Once defined, the system uses SaleTime from the Orders table rather than PaidTime or ShippingTime unless the query generation input explicitly references the time as another option (e.g., clearly as PaidTime or ShippingTime).
Upon an input to generate a query, where the input is “Show the total revenue for the orders in 2022,” the generated SQL code will be:
   SELECT sum(SalePrice)
   FROM Orders
   WHERE isDeleted< >1
   AND SaleTime BETWEEN Jan. 1, 2022 and Dec. 31, 2022;

In contrast, the system is configured to process the query “Show the total revenue for the orders paid in 2022,” and generate the following SQL code is:
SELECT sum (SalePrice)
FROM shopping.order.Orders
WHERE isDeleted< >1
AND PaidTime BETWEEN Jan. 1, 2022 and Dec. 31, 2022;
   The difference in the above example, using the PaidTime column, is based on the system identifying that the query explicitly mentioned “Paid in 2022.” As discussed above, the system is configured to apply default settings, but override such defaults in the presence of explicit requests or language.

### 4) Lookup Values

According to another embodiment, for a given database there are many lookup values. In one example, look-up values can be defined in a table like OrderType or OrderStatus that can be used in a database query. The system is configured to define lookups to establish these values and have them refine any output during query code generation.
CREATE LOOKUP LookupName AS SQL Statement
[WITH Attributes]
   According to various embodiments, the system is configured to accept lookup definitions linking a name and a code statement. The system is also configured to accept attribute specifications. In this example, Attributes are a set of properties defined for the lookup values. Some specific instances include,
CREATE LOOKUP Order_Status
AS SELECT os.OrdersStatusName+‘Orders’
FROM Orders o
JOIN OrderStatus os ON o.OrderId=os.OrderId
WITH PRIMARY KEY: os.OrderStatusId;
   Assuming for a specific database instance that the OrderStatus table has the following value for OrderStatusName:
Created
Paid
Shipped
Canceled
Refunded
   When processed to generate code, the above lookup definition enables the system to process the following phrases in a natural language query:
Created Orders
Paid Orders
Shipped Orders
Canceled Orders
Refund Orders
   For a query “Show total sales of orders shipped in 2022”, the generated SQL produced will be:
SELECT sum (SalePrice)
FROM shopping.order.Orders o
JOIN OrderStatus os ON o.OrderId=os.OrderId
WHERE o.isDeleted< >1 and
AND os.OrderStatusName=‘Shipped’
AND o.ShippedTime BETWEEN Jan. 1, 2022 and Dec. 31, 2022;
   Furthermore, if the attribute PRIMARY KEY: OrderStatusId is used, (e.g., defined in the database dictionary definitions) the query produced may also be optimized as:
SELECT sum (SalePrice)
FROM shopping.order.Orders o
WHERE o.isDeleted< >1 and
AND o.OrderStatusId=30/*Shipped*/
AND o.ShippedTime BETWEEN Jan. 1, 2022 and Dec. 31, 2022;
   In another example, a table has multiple lookup columns, the system enables database dictionary definitions that combine the multiple lookup columns which enable more complex phrases/definitions. For example, OrderType table that has OrderTypeName as follows:
Direct Sale;
Marketplace;
Third Party;
   The system can then create lookup as
CREATE LOOKUP Order_Status_Type
AS SELECT os.OrdersStatusName+‘ ’+ot.OrdersTypeName+‘Orders’
FROM Orders o
JOIN OrderStatus os ON o.OrderStatusId=os.OrderStatusId
JOIN OrderType ot ON o.OrderTypeId=ot.OrderTypeId
WITH PRIMARY KEY os.OrderStatusId,
   PRIMARY KEY ot.OrderTypeId;
      When this lookup is used to create code in response to a user request, the system is configured to process all natural language phrases that combine OrderStatus and OrderType. In this example, the following phrased when requested are then translated into the system in optimized code:
Created Direct Sale Orders
Created Marketplace Orders
Refunded Third Party Orders
Canceled Third Party Orders
. . . .
   According to various embodiments, the system is configured to treat lookup value definitions as an entity in a natural language query. In the examples above the sequence of OrderStatusName and OrderTypeName is not critical because the system resolves the lookup values as an entity. Thus, in various embodiments, the system is configured to process the natural language and produce optimized code outputs regardless of the sequence of words provided.
   To further illustrate operation of the database dictionary system, assume there is a lookup table for Marketplace, that includes the follow columns:
Amazon
eBay
Walmart
Target
   The system is configured to process definitions of additional lookup values, including for example,
Created Amazon Orders
Canceled eBay Orders
Refunded Walmart Orders
   In various embodiments, this permits the system to further refine any generated code in response to natural language inputs as shown above.

### 5) Phrases

In various embodiments, the system is configured to identify and process phrases. Phrases are used to map business terms, concepts, or metrics to database query language. According to one embodiment, the system is configured to accept formal definition of phrases based on the following format:
CREATE PHRASE PhraseName AS Database Query or Expression
[WITH Attributes]
   Described above is an example of processing a defined phrase into query language—Order GMV. The system enables definition of such a phrase, and can be done with the following:
CREATE PHRASE Order GMV AS
SELECT SalePrice+ShippingPrice+SaleTax-Rebate FROM Orders
   In various examples, the system is configured to process many pre-defined phrases, and the pre-defined phrase can be used for date/time functions, for example,
CREATE PHRASE Yesterday AS
BETWEEN DATEADD(day, −1, CAST(GETDATE( ) AS date)) AND CAST(GETDATE( ) AS date);
CREATE PHRASE Last 24 Hours AS
BETWEEN DATEADD(Hour, −24, GETDATE( )) AND GETDATE( )
   Another example for a phrase is:
CREATE PHRASE Paid Order AS
SELECT * FROM Orders WHERE PaidTime IS NOT NULL;
   In further options that permit refinement of generated code, Orders may have a status “Paid” so it is possible for the system to use a lookup value Paid Orders from the following lookup definition:
SELECT os.OrderStatusName+‘Orders’
FROM Orders
JOIN OrderStatus os ON o.OrderStatusId=os.OrderStatusId
WHERE os.isDeleted< >1 and
AND os.OrderStatusName=‘Paid’
   Various embodiments are configured to resolve any potential issues that may result from definition conflicts. In the above example, the query that would be generated without conflict resolution would be incorrect because paid status is a temporary status and it may be changed to shipped after the order is shipped. Therefore, if a query that the user is trying to generate needs to count the total number of Paid orders, the system can leverage a prioritization to resolve conflicts. In this example, the system is configured to give the Phrase definition as a default a higher priority than a lookup value definition. With the prioritization the system will then produce a query so that the criteria PaidTime IS NOT NULL is used in SQL query instead of OrderStatusName=‘Paid’. Once prioritization is applied, the following code can be generated in response to a natural language input.
SELECT count(*) FROM Orders WHERE isDeleted< >1 and PaidTime IS NOT NULL;
   The example and considerations above are described to illustrate the difference between lookup values and phrases, and also show how the system uses a phrase to translate business logic in the database dictionary.

### 6) Alias

According to some embodiments, there can be many inconsistent names or terminology used in a company and natural language settings. This can be apparent in how different groups in an organization use certain terms. For example, a glossary used by business groups can be different from the same terms used by a group of IT Developers. Thus, the system is configured to use an alias to provide for resolving these usages. In one example, an alias is used to define equivalents of these terms so people or LLMs can understand all of them, and generate code outputs that account for the usage of the identical natural language. In addition, people may use some abbreviations in natural language query, for example, OID for OrderId, CID for ClientId or CustomerId, UID for UserId etc. The system enables translation of these abbreviations, which can be defined as an alias.
According to one embodiment, the system is configured to accept formal definition of an alias as follows:
CREATE ALIAS AliasName AS
(TableGroupName|ColumnName|Lookup|Phrase|Join|Union|Comment];
   Some examples of a defined alias include:
CREATE ALIAS Client AS Customer;
CREATE ALIAS CID AS CustomerID;
CREATE ALIAS ReportTo AS Manager;
CREATE ALIAS Invoice Total AS Invoice Amount;

According to one embodiment, the system can be configured to identify the definition for an aliased term based on the user entering the natural language input or based on the target of the natural language input.

### 7) Joins

According to one embodiment, the formal definition for JOINs is as follows:
CREATE JOIN JoinName AS database query;

In many instances, and for example, with SQL query execution, Join is one of the most important operations for database queries. According to some embodiments, the system can be configured to create join definitions automatically for the database dictionary. According to one example, the system can analyze a database schema and determine that joins optimize natural language translation into query code.

According to one embodiment, the system is configured to identify foreign key constraints, as they may imply the two tables referenced in the FK constraint can be joined through the Primary/Foreign Key. In some embodiments, if the two tables linked by the FK constraint have a column with a same name or type, the system is configured to define a join to link them together by the column.

However, there are some important joins that may not be defined by a database schema implicitly. For example, if a database has an InvoiceItem table as follows:

| | | | | |
|---|---|---|---|---|
| InvoiceItemId | InvoiceItemType | Amount | ReferenceID | CreateTime |

This table has ReferenceID to indicate where the invoice Item comes from as follows:
If the InvoiceItemType is “Order”, the ReferenceID is OrderId from Orders table;
If the InvoiceItemType is “Refund”, the ReferenceID is RefundId from Refund table;
If the InvoiceItemType is “Shipping”, the ReferenceID is ShippingDetailId from ShippingDetail table;
   Thus, the system defines the following joins in the database dictionary to optimize LLM outputs and/or to help a developer to understand the logic:

CREATE JOIN Order Invoices AS
SELECT *
FROM Invoices i
JOIN InvoiceItems ii on ii.InvoiceId=i.InvoiceId
JOIN Orders o on o.OrderId=ii.ReferenceId AND ii.InvoiceItemType=
’Order’;
CREATE JOIN Shipping Invoices AS
SELECT *
FROM Invoices i
JOIN InvoiceItems ii on ii.InvoiceId=i.InvoiceId
JOIN ShippingDetail sd on sd.ShippingDetailId=ii.ReferenceId
AND ii.InvoiceItemType= ′Shipping’;

These JOINs show how to map English phrases “Order Invoices” and “Shipping Invoices” to a database query in SQL. In some embodiments, the system is able to provide for special joins in a respective database. For example, the system is configured to extract join information from existing reports and/or from views as a stored procedure. In other examples, the system can enable users to add join information manually.

### 8) Unions

Union is an operation used in many database queries when the database/data set includes large tables with partitions. For example, an Orders table can become large as a business is growing, so a DBA may need to archive or partition it to improve query performance. Common partitions can be based on year, for example, Orders in year of 2020, Orders in year of 2021 etc. In such a setting, the current Orders table only stores information on new orders from last year, because most queries only need search data from last year. However, if a query needs data more than one year, the Union will be used.

The formal definition of Union is as follows:

CREATE UNION UnionName AS
SELECT * FROM TableName1 [WHERE Clause]
UNION [ALL]
SELECT * FROM TableName2 [WHERE Clause]
UNION [ALL]
......

Here WHERE Clause is used to define the partition criteria in the table.

An example of UNION is:

```
  CREATE UNION All Orders AS
  SELECT * FROM Orders WHERE SaleTime >= ’01/01/2022’
  UNION
  SELECT * FROM Orders2021 WHERE SaleTime >= ’01/01/2021’
and SaleTime < ’01/01/2022’
  UNION
  SELECT * FROM Orders2020 WHERE saleTime >= ’01/01/2020’
and saleTime < ’01/01/2021’
```

When the system has to process a natural language query “How many orders we have since 2020 and what is the total sales?”, the system uses the union definitions in the database dictionary to optimize the output generated by the LLM and produce a translated SQL query as follows:

```
SELECT COUNT(*) AS OrderCount, SUM(SalePrice) as TotalSales
FROM (SELECT * FROM Orders
  UNION ALL
  SELECT * FROM Orders2021
  UNION ALL
  SELECT * FROM Orders2020
) as o WHERE o.SaleTime >= ’01/01/2020’.
```

This enables the generated query code to include table Order2021 and Order2020 for old orders. Conventional approaches lack the understanding of the database that is needed to link these partitions. Without that understanding conventional approaches cannot generate the code above. In various embodiments, the system is configured to analyze a given database schema to identify partitioned data. For example, the system can be configured to automatically create union definitions in the database dictionary based on identifying partitioned tables by analyzing common naming, which can be validated by evaluating such tables for commonality in column name, data, etc.

### 9) Comment

According to one embodiment, a comment is natural language descriptions on database objects or business terms. The inventors have realized that comments are sometimes more useful to LLMs than to database schema because the latter may use abbreviations or even meaningless letters or digits as table name or column name, and often results in the LLM not understanding potential connections. In various examples, comments are written in natural language so comments can improve the ability of LLMs to incorporate and/or intercept business terms or concepts. According to one example, the system can include “comment” for the term BXF as follows:
CREATE COMMENT BXF AS Broadcast Exchange Format, used in TV industry exchange media data.
When a LLM is asked by question: How many BXF deliveries we have, the system can is configured to leverage the comment to link the question to table Media and Deliveries, and generate SQL as: SELECT count(*) FROM Deliveries d JOIN Media m on d. Media Id=m. MediaId AND m. is BXF=1

### Example Natural Language Definition of a Database Dictionary

Various embodiments use formal definition of a database dictionary which are analogous to the code (e.g., SQL) that will be output from a natural language request. In other embodiments, the information shown in the formal construct can be defined or encoded in other ways. For example, the information shown in the formal constructs can be defined with natural language statements.

According to one example, the database dictionary can define information about a database as follows:
Orders is a table with schema of CREATE TABLE Orders ( . . . );
   In some examples, any schema can be incorporated into the database dictionary
   In other examples, character/size limits may be applied to a schema
SaleTime is Default Time for table Orders;
iPhone 14 Case is a lookup value as Select ProductSubTypeName+‘ ’+ProductTypeName from ProductType pt join ProductSubType pst ON pt.ProductId=ProductId;
Yesterday is a phrase as BETWEEN DATEADD(day, −1, CAST(GETDATE( ) AS date)) AND CAST(GETDATE( ) AS date);
Paid Order is a phrase as select * from orders where isDeleted< >1 and PaidDate is not null;
ReportTo is an alias of Manager;
InvoiceItems table and Orders table are joined as SELECT * FROM InvoiceItems ii JOIN Orders o ON o.OrderId=ii.ReferenceId AND ii.InvoiceItemType=‘Order’;
. . . .

As shown above, the information in the database dictionary may be presented in many different ways. The format does not matter. In various embodiments, the content and logic defined by database dictionary examples above are all that needs to be reflected in order to optimize the translation from natural language into executable query code.

### Examples of Generation of a Database Dictionary

Various embodiments can use any one or more or any combination of the following methodologies for building a database dictionary.

### 1) Automation

According to one embodiment, a database dictionary can be created automatically. The automatic process can be based on pre-defined rules (e.g., applying descriptions above), extracted from existing reports on a database, captured from database views, report options, or stored procedures (e.g., report/view/procedure naming conventions, fields, summaries, etc., can be used to define table groups, attributes, lookup values, phrases, alias, joins, or unions) or Dynamic SQL statements, which Dynamic SQL statements refer to real-time SQL statements executed by applications or users. For a well-designed database (e.g., well defined schema), the table structure and/or naming conventions follow similar rules, allowing the system to infer the database architecture, for example, based on common naming structures, or reporting naming conventions, among other options. Thus the system can create a database dictionary accurately from available schema information, reports, database views, etc. According to one example, the system is configured to produce a database dictionary automatically as follows:
The tables which are referenced by foreign keys and name with same prefix are used to create a table group;
The value from table name ending with Type or Status, e.g. OrderType, OrderStatus, ProductType etc., are used to generate lookup values;
Two tables that are referenced by foreign keys are joined together;
Tables with exact same structure may be unioned;

### 2) Supervised Learning

According to another embodiment, a supervised learning process can use labeled datasets created from existing views, reports, or stored procedures to train a neural network to classify data. For a well-defined database, the table structure and/or naming conversion follow similar rules (e.g., naming conventions), so the system can use supervised learning to predict outcomes accurately. For example, most lookup tables should be named in a similar way in a database so it is good for supervised learning to identify all of them based on a small set of training data.

According to one embodiment, the database dictionary system includes screen guides that are configured to prompt users to supply labels on specific data properties as part of the creation of a database dictionary. The labeled data can then be used to train the neural network to classify a database/schema to provide the definitions of table groups, attributes, lookup values, phrases, aliases, joins, and/or unions. In other embodiments, the automation processes described above can be used to generate label data with the database/schema, and a neural network trained to classify similar information (e.g., automatic identification of lookup table used to train networks to recognize tables with similar properties, etc.).

### 3) Manual

In some embodiments, a database dictionary can be defined manually by a DBA, data engineer, or developer. In some examples, the database dictionary system can include screen guides to interrogation or walk a user through defining information about their source database and/or schema that simplifies manual definition of database dictionary information (e.g., table groups, attributes, lookup values, phrases, alias, joins, and/or unions, etc.).

Examples are discussed below with respect to constructing a database dictionary that can use any one or any combination or the three methodologies above. The following description highlights build considerations for each of the example elements described above for a database dictionary:

### Database Schema

All database management systems provide ways to read a database schema, which permits the database dictionary system to capture this information automatically.

### Table Group

The system is configured to identify tables referenced by foreign keys and evaluate the names of those tables. The tables with the same prefix can be used to automatically define a table group. Additional relationships between tables that are not presented via foreign keys can be added manually, or in another example, an unidentified table group can be identified as similar to a labeled table group using an intelligent model.

### Attributes

Some attributes can be added automatically based on pre-defined rules executed by the system. For example, default constraint IsDeleted< >1 can be added if there is a rule that any table has the default constraint isDeleted< >1 if isDeleted is a column in the table. A default time column can be added manually by a DBA/Developer.

### Lookup Values

Lookup values can be created from lookup tables automatically. The lookup tables can be defined by rules, for example,
a) The table name is ended with word Type or Status, or matches regular expressions;
b) The row number in the table is less than 1000;
c) There is a text column which length is less than 128;

For lookup tables which are not covered by the above rules, for example, a VideoFormat table, the system can operate without that definition. However, further optimization can be realized with having a DBA/Developer manually generate a lookup value for the database dictionary. In some settings, the system can use a post automatic database dictionary generation review session and display screens to the user to prompt the user to enter information on their database, data source, and/or schema that has not been defined in the database dictionary.

### Phrases

According to one embodiment, the system is configured with pre-defined phrases for a specific DBMS. The system requests information on a DBMS or automatically recognized based on a database schema what DBMS is employed. The system accesses a set of matching pre-defined Phrases, for example, yesterday (or last day), next day, the first day of this month, the last day of this month, last month (previous month), this month etc. and uses that information to generate phrase definitions in the database dictionary.

For business terms or glossaries, the system can be configured to extract business terms from current reports or database views. In addition, the system can also be used to add phrases manually.

### Alias

Many NLP libraries or online sites (e.g., thesaurus.com, etc.), provide a set of synonyms which can be used to create some Alias definitions automatically. In addition, for business special terms or for a glossary, user supplied reports can be used to define an alias. In further examples, special terms or glossary definitions can be added manually.

### Join:

According to various embodiments, joins can be created automatically based on rules, for example, the system can create a join definition if two tables have a foreign key referenced. In addition, further verification can be used. If the two tables also have a column with a same name, type, and/or size, the system can create a join for them. For special joins, the system is configured to extract special joins from current database views or reports. As with other options, the system also enables manual definition.

### Union:

As discussed above, Unions can be created automatically. For example, the system can identify tables which have the same columns in name, type and size, and define unions on that basis.

### Comment:

According to various embodiments, comments can be extracted from the comments embedded within the source code of views or stored procedures. In various examples, the comments are used to explain the logic behind a block of code, or make notes for future reference. Comments can be extracted and added to database dictionary as comments

The figure described below illustrates a process flow for constructing a database dictionary, including operations that are executed automatically.

According to some embodiments, each additional element of description of a target database, enables the database dictionary system to produce query code that is more optimized and improved in functional alignment relative to generic LLM or other generative AI models. In various examples, any one of the data descriptions above can be leveraged by the database dictionary system to improve the code outputs produced. With each addition of additional description, each union definition, join definition, alias definition, the system and associated output is improved over conventional approaches. Thus, the system can leverage any generation of database dictionary definition to improve the output produced by an associated LLM or AI model. In yet other embodiments, the system can use any such description to fine tune the underlying model itself, enabling the fine-tuned model to predict query outputs that match the context of a specific database implementation. Such fine-tuned models may be tailored and/or associated with specific databases, and the system can be configured to allow a user to designate a fine-tuned model so that it matches the database the user wishes to target.

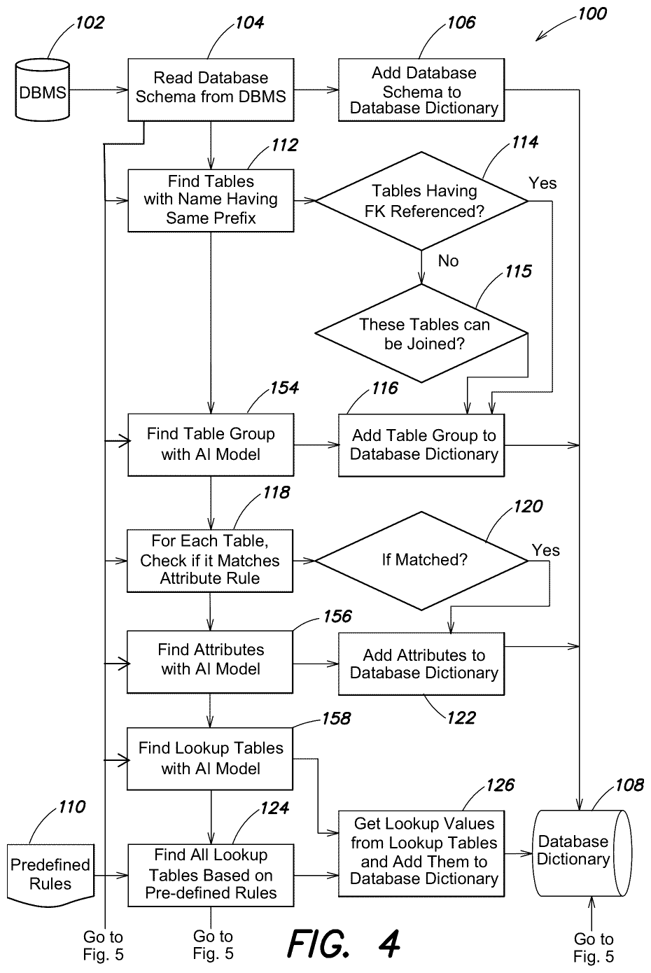

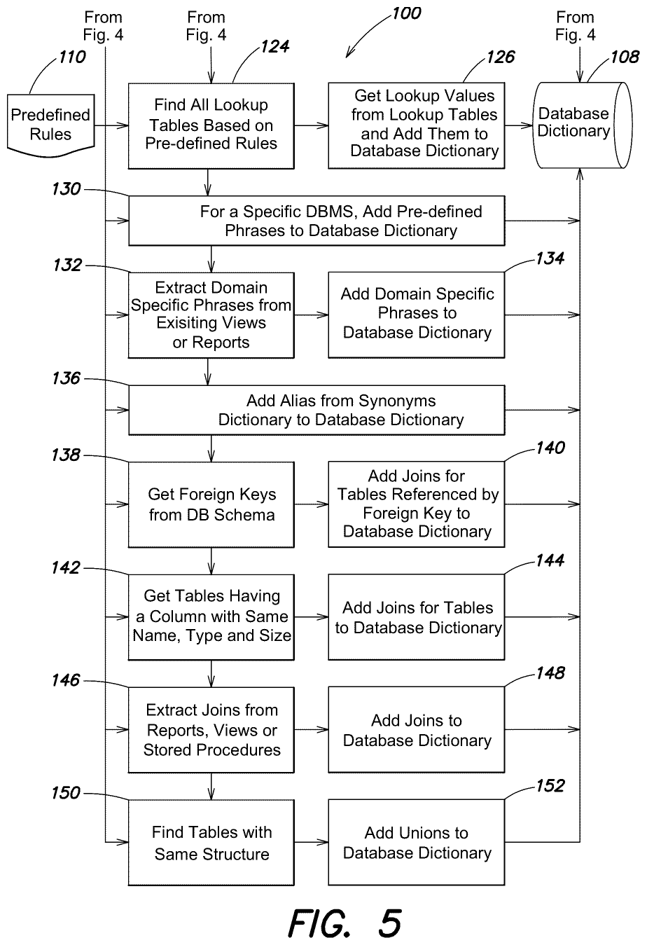

Shown in FIGS. 4 and 5 is a process flow 100 for building a database dictionary. The process 100 can begin at 102 with access to a database management system. The process can continue at 104 with reading a database schema from the database management system. In other examples, the schema can be provided directly. At 106, the database schema can be added to the database dictionary (e.g. 108). Process 100 can continue with the execution of predefined rules on the data from the database management system (110-112). For example process 100 can find tables having the same prefix in their name at 112 based on information in the database schema or the database itself. At 114 if the tables with the same name prefix have a foreign key reference in common, those tables can be added to a table group definition (e.g. 116) in the database dictionary (e.g. 108). If the tables do not have a foreign key reference, process 100 can evaluate whether or not the tables can be joined at 115. If they can be joined the tables can be added to a table group definition at 116 in the database dictionary 108. If not, process 100 continues to evaluate the database information at 118. Table groups may also be found using an AI model, including for example, a supervised learning model at 154. When identified via the AI model at 154, the table group is added to the database dictionary at 116.

Each table defined in the schema will be checked against an attribute rule for matches at 118. If there is a match at 120, the attribute definition will be added (122) to the database the dictionary 108. Attributes definition can be added to the database dictionary at 122, based on identifying attributes with an AI model at 156. For example, a supervised learning model can be used to identify attributes at 156, and add them to the database dictionary at 122.

Process 100 is configured to find all lookup tables within the database information based on predefined rules (e.g. described above). At 126, process 100 will get lookup values from the lookup tables and add them to the database dictionary 108. In addition, lookup values can be added to the database dictionary using an AI model, including for example, a supervised learning model at 158 that identifies look-up tables within the database or database schema.

Shown in FIG. 5 is the continuation of process 100. At the top of FIG. 4 shown are the common elements of FIG. 4 in FIG. 5 (110, 124, 126, 108). Process 100 can continue at 130 with the addition of predefined phrases to the database dictionary 108 for a specific database management system. Further processing is executed at 132 where domain specific phrases are extracted from existing views or reports. The extracted information is added to the database dictionary as domain specific phrases at 134. At 136, the process 100 is configured to construct alias information using synonyms or a synonyms dictionary, and adds those alias definitions to the database dictionary at 108. Foreign key references can be captured at 138 and join definitions for tables referenced by foreign key can be added to the database dictionary 108, for example, as part of step 140. Evaluation of the data from the database management system can include identifying tables that have a column with the same name, type, and size at 142. Join definitions for the identified tables can be added to the database dictionary at 144. Joins may also be identified from reports, database views, or stored procedures at 146. The identified joins can be added to the database dictionary at 148. Analysis of the data from the database management system can also include identifying tables that have the same structure at 150 the identified tables that have the same structure can be used to generate union definitions, and the union definitions added to the database dictionary at 152.

Various embodiments are configured to execute process 100 in whole and or in part to evaluate and build a database dictionary definition. As discussed, each detail added to a dictionary definition enables the system to improve the construction of a query code output. Thus, execution of any subset of steps that adds to information to the database dictionary improves the goal of producing better query code.

According to some embodiments, a database dictionary definition can also be used to improve and tailor any code generation to specific settings. For example, a request to a large language model to produce code to calculate or execute a specific function will produce a generic output where field names in the code produced are linked to the text input. By providing a database dictionary definition (e.g., on a target program or a database linked to a programmatic setting) in conjunction with a request to produce executable code, the output can be tailored to a specific function having already named variables, methods, procedures, etc., and the produced code will be aligned to that context. In further embodiments, database dictionary definitions can be used to improve translation between code languages, improve targeting of generated code, among other options, by integrating specific programmatic or associated database contexts to a request.

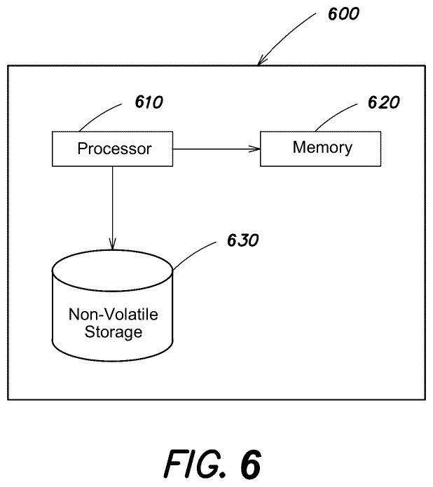

FIG. 6 is a block diagram of an example computer system that is improved by implementing the functions, operations, and/or architectures described herein. Modifications and variations of the discussed embodiments will be apparent to those of ordinary skill in the art and all such modifications and variations are included within the scope of the appended claims. Additionally, an illustrative implementation of a computer system 600 that may be used in connection with any of the embodiments of the disclosure provided herein is shown in FIG. 6. The computer system 600 may include one or more processors 610 and one or more articles of manufacture that comprise non-transitory computer-readable storage media (e.g., memory 620 and one or more non-volatile storage media 630). The processor 610 may control writing data to and reading data from the memory 620 and the non-volatile storage device 630 in any suitable manner. To perform any of the functionality described herein (e.g., image reconstruction, anomaly detection, etc.), the processor 610 may execute one or more processor-executable instructions stored in one or more non-transitory computer-readable storage media (e.g., the memory 620), which may serve as non-transitory computer-readable storage media storing processor-executable instructions for execution by the processor 610.

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationships between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples (e.g., the processes described herein) have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

In other embodiments, various ones of the functions and/or portions of the flows discussed herein can be executed in different order. In still other embodiments, various ones of the functions and/or portions of the flow can be omitted, or consolidated. In yet other embodiments, various ones of the functions and/or portions of the flow can be combined, and used in various combinations of the disclosed flows, portions of flows, and/or individual functions. In various examples, various ones of the screens, functions and/or algorithms can be combined, and can be used in various combinations of the disclosed functions.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

All definitions, as defined and used herein, should be understood to control over dictionary definitions, and/or ordinary meanings of the defined terms. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A system for generating query code in response to a natural language input, the system comprising:
at least one processor operatively connected to a memory, the processor when executing configured to:
accept a request comprising a natural language input;
associate the natural language input with a database dictionary definition;
input the natural language and database dictionary definition into a large language model configured to produce query code;
capture a query code output tailored to the request and the database dictionary definition; and
display the query code output.

2. The system of claim 1, wherein the database dictionary definition comprises summary information associated with the target database or a database schema of the target database.

3. The system of claim 1, wherein the system is configured to access a database dictionary definition responsive to selection in a user interface.

4. The system of claim 1, wherein the system is configured to update the database dictionary definition responsive to manual input in a user interface.

5. The system of claim 1, wherein the at least one processor is configured to:
accept database schema information; and
automatically generate at least a portion of the database dictionary definition.

6. The system of claim 5, wherein the automatically generated code includes at least one of a table group definition, join definition, attribute definition, phrase definition, alias definition, or look up definition, union definition, or comment definition.

7. The system of claim 1, wherein the at least one processor is configured to fine-tune the large language model by the input of database dictionary definition.

8. The system of claim 1, wherein the at least one processor is configured to:
accept information for a database architecture for a target database;
execute a plurality of rules on the information for the database architecture;
automatically define table groups based on relationships established in the target database or a database schema associated with the target database based on execution of the plurality of rules; and
store a database dictionary including at least the table groups for optimizing query code generation.

9. The system of claim 8, wherein the at least one processor is configured to automatically define at least one of a join definition, an attribute definition, a phrase definition, an alias definition, a look up definition, union definition, or a comment definition based on execution of the plurality of rules.

10. The system of claim 1, wherein the at least one processor is configured to:
accept information for a database architecture for a target database;
execute at least a plurality of rules on the information for the database architecture; and
automatically define at least one of a table group, a join definition, an attribute definition, a phrase definition, an alias definition, a look up definition, a union definition, or a comment definition based on execution of the plurality of rules; and
store a database dictionary including at least the table groups for optimizing query code generation.

11. A computer implemented method for generating query code in response to a natural language input, the method comprising:
accepting, by at least one processor, a request comprising a natural language input;
associating, by the at least one processor, the natural language input with a database dictionary definition;
inputting, by the at least one processor, the natural language and database dictionary definition into a large language model configured to produce query code;
capturing, by the at least one processor, a query code output tailored to the request and the database dictionary definition; and
displaying, by the at least one processor, the query code output.

12. The method of claim 11, wherein the database dictionary definition comprises summary information associated with the target database or a database schema of the target database.

13. The method of claim 11, wherein the method comprises accessing, by the at least one processor, a database dictionary definition responsive to selection in a user interface.

14. The method of claim 11, wherein the method comprises updating, by the at least one processor, the database dictionary definition responsive to manual input in a user interface.

15. The method of claim 11, wherein the method comprises:
accepting, by the at least one processor, database schema information; and
automatically generating, by the at least one processor, at least a portion of the database dictionary definition.

16. The method of claim 11, wherein the automatically generated code includes at least one of a table group definition, join definition, attribute definition, phrase definition, alias definition, or look up definition, union definition, or comment definition.

17. The method of claim 11, wherein the method comprises fine-tuning, by the at least one processor, the large language model by the input of database dictionary definition.

18. The method of claim 11, wherein the method comprises:
accepting, by the at least one processor, information for a database architecture for a target database;
executing, by the at least one processor, a plurality of rules on the information for the database architecture;
automatically defining, by the at least one processor, table groups based on relationships established in the target database or a database schema associated with the target database based on execution of the plurality of rules; and
storing, by the at least one processor, a database dictionary including at least the table groups for optimizing query code generation.

19. The method of claim 18, wherein the method comprises automatically defining, by the at least one processor, at least one of a join definition, an attribute definition, a phrase definition, an alias definition, a look up definition, union definition, or a comment definition based on execution of the plurality of rules.

20. The method of claim 11, wherein the method comprises:
accepting, by the at least one processor, information for a database architecture for a target database;
executing, by the at least one processor, at least a plurality of rules on the information for the database architecture; and
automatically define at least one of a table group, a join definition, an attribute definition, a phrase definition, an alias definition, a look up definition, a union definition, or a comment definition based on execution of the plurality of rules; and
store a database dictionary including at least the table groups for optimizing query code generation.
